(19) United States
(12) Patent Application Publication
(10) Pub. No.: US 2022/0180023 A1
(43) Pub. Date: Jun. 9, 2022

(54) Speed Tracking Control Method and System for Heavy-Haul Train

(71) Applicant: East China Jiaotong University, Nanchang City (CN)

(72) Inventors: Hui Yang, Nanchang City (CN); Aili Jin, Nanchang City (CN); Yating Fu, Nanchang City (CN); Zhongqi Li, Nanchang City (CN); Chang Tan, Nanchang City (CN)

(21) Appl. No.: 17/196,443

(22) Filed: Mar. 9, 2021

(30) Foreign Application Priority Data
Dec. 4, 2020 (CN) 202011398310.5

(51) Int. Cl. G06F 30/25; B61L 25/02; B61L 27/00; B61D 3/00

(52) U.S. Cl. CPC G06F 30/25; B61L 25/021; G06F 2111/10; B61D 3/00; B61L 27/0055

(57) ABSTRACT

The present disclosure provides a speed tracking control method and system for a heavy-haul train. According to the present disclosure, a multi-particle unit-displacement model of the train is established and a robust-adaptive active disturbance rejection control method is adopted, so that an error between an actual speed of the train and a target speed is minimized, an anti-interference capacity of the heavy-haul train is improved, and high-precision tracking control over the target speed of the train is realized.

### TECHNICAL FIELD

The present disclosure relates to the technical field of automatic control of heavy-haul train operation, and in particular, to a speed tracking control method and system for a heavy-haul train.

### BACKGROUND

Heavy-haul railways have the advantages of large transportation volume, high speed, low energy consumption, low costs, and all-weather operation, making heavy-haul transportation the main development trend of the world's railway freight transportation. However, there are still problems in heavy-haul transportation, for example, complex characteristics of trains, huge external interference, and high intensity and difficulty of running operations. To overcome the foregoing problems and improve the control level of the train, it is necessary to analyze the train itself and establish a precise mathematical model of train. It is also necessary to study a suitable control algorithm to control the operation process of the train, and this is also an important development direction for improving the heavy-haul train technology currently.

As for the modeling of the operation process of heavy-haul train, one method is to establish a single-particle model, which regards the train as a whole. Although it is easy to describe the overall operation condition of the train by using the single-particle model, the model ignores the mutual influence between the cars of the train and cannot meet the requirement of safe train control. The other method is to establish a multi-particle model, which regards each car of the train as a particle and the entire train as a chain of particles. Although the multi-particle model of the train takes the interaction between cars into consideration and is close to the real operation of the train, the multi-particle dynamics equation generally involves an excessively large amount of computation, causing the control process to be highly complex.

For operation control of the heavy-haul train, some scholars adopt fuzzy control to implement heavy-haul intelligent control, but it is complex to establish a fuzzy membership function, which is adverse to real-time tracking of the train. Some people have made some achievements in performance indicators such as energy saving, punctuality and stopping accuracy of the train by using a strategy of combining predictive control and gray control. Others have studied a method for automatic operation of urban rail transit trains based on improved predictive control, which optimizes multiple goals by reducing overshoots, and performs multi-step prediction, online optimization, and feedback correction on optimization results. In a word, current control methods for train operation mainly include predictive control, fuzzy control, adaptive control, neural network control or a combination of multiple control theories. However, these studies do not provide particular processing for unmodeled dynamics of the train and unknown external disturbances, are highly dependent on models, and involve complex calculations, thus failing to meet the requirement on real-time performance during actual operation of the train. As a result, the train cannot track a target speed curve accurately.

### SUMMARY

The present disclosure aims to provide a speed tracking control method and system for a heavy-haul train, to improve an anti-interference capacity of the heavy-haul train and allow the train to implement high-precision tracking control over a target speed by establishing a multi-particle unit-displacement model of the train and using a robust-adaptive active disturbance rejection control method.

To achieve the above objective, the present disclosure provides the following solutions: A speed tracking control method for a heavy-haul train includes: establishing a multi-particle unit-displacement model of the heavy-haul train; obtaining, based on a target speed, a transient process and a speed derivative of the target speed by using a tracking differentiator; determining, based on an actual speed of the heavy-haul train, a speed estimate, a speed derivative estimate, and a total disturbance estimate by using an extended state observer; calculating an error between the transient process and the speed estimate as a first error; calculating an error between the speed derivative and the speed derivative estimate as a second error; designing, based on a robust adaptive method, a control law for the first error and the second error by using a nonlinear-combination error feedback device, to obtain a virtual control amount; obtaining an actual control amount according to the virtual control amount and the total disturbance estimate; and controlling the multi-particle unit-displacement model of the heavy-haul train according to the actual control amount, to realize speed tracking.

Optionally, the establishing a multi-particle unit-displacement model of the heavy-haul train specifically includes: establishing a multi-particle model of the heavy-haul train according to a dynamics equation of the heavy-haul train; transforming the multi-particle model of the heavy-haul train into a unit-displacement model containing only one reference particle displacement by using a geometric relationship between adjacent cars; and transforming the unit-displacement model containing only one reference particle displacement into the multi-particle unit-displacement model of the heavy-haul train by using a principle of “action force and reaction force”.

Optionally, the multi-particle model of the heavy-haul train is as follows:

$$\{ \begin{matrix}{m}_{1} {\ddot{x}}_{1} = {U}_{1} - {F}_{C 1} - {F}_{W 1} \\ {m}_{2} {\ddot{x}}_{2} = {U}_{2} + {F}_{C 1} - {F}_{C 2} - {F}_{W 2} \\ … \\ {m}_{i} {\ddot{x}}_{i} = {U}_{i} + {F}_{C i - 1} - {F}_{C i} - {F}_{W i} \\ … \\ {m}_{n} {\ddot{x}}_{n} = {U}_{n} + {F}_{C n - 1} - {F}_{C n} - {F}_{W n}\end{matrix}$$

where mᵢ represents the mass of the i-th car of the train; \ddot{x}₁ represent an acceleration of the i-th car; Uₜ represents a traction/braking force of the i-th car of the train; F_{Ci-1} and F_{Ci} represent a front coupler force and a rear coupler force of the i-th car respectively; and F_{Wi} represents a basic resistance of the i-th car.

Optionally, the multi-particle unit-displacement model of the heavy-haul train is as follows:

M\dot{v}ₐ=U−F_{W}−F_{L}

where M is the total mass of the train; U is a control amount applied to the train; F_{L} is mutual influence of other cars on a reference car; F_{W} is a total resistance of the train; if a displacement of the reference car of the heavy-haul train is defined as xₐ, then \dot{x}ₐ=vₐ; vₐ and \dot{v}ₐ are a speed and an acceleration of the reference car respectively.

Optionally, a formula for calculating the actual control amount is as follows:

$$u = \frac{{u}_{0} - {z}_{3}}{{b}_{0}}$$

where u represents the actual control amount, u₀ represents the virtual control amount, b₀ represents a compensation factor, and z₃ represents the total disturbance estimate.

The The present disclosure further provides a speed tracking control system for a heavy-haul train, including: a model establishment module, configured to establish a multi-particle unit-displacement model of the heavy-haul train; a first parameter determining module, configured to obtain, based on a target speed, a transient process and a speed derivative of the target speed by using a tracking differentiator; a second parameter determining module, configured to determine, based on an actual speed of the heavy-haul train, a speed estimate, a speed derivative estimate, and a total disturbance estimate by using an extended state observer; a first error calculation module, configured to calculate an error between the transient process and the speed estimate as a first error; a second error calculation module, configured to calculate an error between the speed derivative and the speed derivative estimate as a second error; a virtual control amount determining module, configured to design, based on a robust adaptive method, a control law for the first error and the second error by using a nonlinear-combination error feedback device, to obtain a virtual control amount; an actual control amount determining module, configured to obtain an actual control amount according to the virtual control amount and the total disturbance estimate; and a control module, configured to control the multi-particle unit-displacement model of the heavy-haul train according to the actual control amount, to realize speed tracking.

Optionally, the model establishment module specifically includes: a unit for establishing multi-particle model of heavy-haul train, configured to establish a multi-particle model of the heavy-haul train according to a dynamics equation of the heavy-haul train; a transformation unit, configured to transform the multi-particle model of the heavy-haul train into a unit-displacement model containing only one reference particle displacement by using a geometric relationship between adjacent cars; and a unit for establishing multi-particle unit-displacement model of heavy-haul train, configured to transform the unit-displacement model containing only one reference particle displacement into the multi-particle unit-displacement model of the heavy-haul train by using a principle of “action force and reaction force”.

Optionally, the multi-particle model of the heavy-haul train is as follows:

$$\{ \begin{matrix}{m}_{1} {\ddot{x}}_{1} = {U}_{1} - {F}_{C 1} - {F}_{W 1} \\ {m}_{2} {\ddot{x}}_{2} = {U}_{2} + {F}_{C 1} - {F}_{C 2} - {F}_{W 2} \\ … \\ {m}_{i} {\ddot{x}}_{i} = {U}_{i} + {F}_{C i - 1} - {F}_{C i} - {F}_{W i} \\ … \\ {m}_{n} {\ddot{x}}_{n} = {U}_{n} + {F}_{C n - 1} - {F}_{C n} - {F}_{W n}\end{matrix}$$

where mᵢ represents the mass of the i-th car of the train: xx represent an acceleration of the i-th car; Uᵢ represents a traction/braking force of the i-th car of the train; F_{Ci-1} and F_{Ci} represent a front coupler force and a rear coupler force of the i-th car respectively; and F_{Wi} represents a basic resistance of the i-th car.

Optionally, the multi-particle unit-displacement model of the heavy-haul train is as follows:

M\dot{v}ₐ=U−F_{W}−F_{L}

where M is the total mass of the train; U is a control amount applied to the train; F_{L} is mutual influence of other cars on a reference car; F_{W} is a total resistance of the train; if a displacement of the reference car of the heavy-haul train is defined as xₐ, then \dot{x}ₐ=vₐ; vₐ and \dot{v}ₐ are a speed and an acceleration of the reference car respectively.

Optionally, a formula for calculating the actual control amount is as follows:

$$u = \frac{{u}_{0} - {z}_{3}}{{b}_{0}}$$

where u represents the actual control amount, u₀ represents the virtual control amount, b₀ represents a compensation factor, and z₃ represents the total disturbance estimate.

According to specific embodiments of the present disclosure, the present disclosure provides the following technical effects: The present disclosure provides a speed tracking control method and system for a heavy-haul train. According to the present disclosure, a multi-particle unit-displacement model of the train is established and a robust-adaptive active disturbance rejection control method is adopted, so that an error between an actual speed of the train and a target speed is minimized, an anti-interference capacity of the heavy-haul train is improved, and high-precision tracking control over the target speed of the train is realized.

### BRIEF DESCRIPTION OF THE DRAWINGS

To describe the technical solutions in embodiments of the present disclosure or in the prior art more clearly, the accompanying drawings needed in the embodiments will be introduced below briefly. Apparently, the accompanying drawings in the following description show merely some embodiments of the present disclosure, and other drawings can be derived from these accompanying drawings by those of ordinary skill in the art without creative efforts.

FIG. 1 is a flowchart of a speed tracking control method for a heavy-haul train according to an embodiment of the present disclosure;

FIG. 2 is a block diagram of an active disturbance rejection control principle of a heavy-haul train in a multi-particle unit-displacement model according to an embodiment of the present disclosure;

FIG. 3 is a diagram of simplified car connection of a heavy-haul train according to an embodiment of the present disclosure;

FIG. 4 shows a comparison between target speed tracking under an active disturbance rejection controller and a PID controller in the presence of interference according to an embodiment of the present disclosure, where the solid curve is a target speed, the dotted curve is a tracking speed of a heavy-haul train under the active disturbance rejection controller, and the dash-dotted curve is a tracking speed of the heavy-haul train under the PID control;

FIG. 5 shows a speed tracking error curve of a heavy-haul train under two types of controllers according to an embodiment of the present disclosure, where the solid curve is an error under the active disturbance rejection control, and the dash-dotted curve is an error under the PID control;

FIG. 6 is a schematic diagram of a control force of an active disturbance rejection controller; and

FIG. 7 is a schematic diagram of a control force of a PID controller.

### DETAILED DESCRIPTION

The following clearly and completely describes the technical solutions in the embodiments of the present disclosure with reference to the accompanying drawings in the embodiments of the present disclosure. Apparently, the described embodiments are merely some of rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a speed tracking control method and system for a heavy-haul train, to improve an anti-interference capacity of the heavy-haul train and allow the train to implement high-precision tracking control over a target speed by establishing a multi-particle unit-displacement model of the train and using a robust-adaptive active disturbance rejection control method.

The technical solution of the present disclosure is as follows: In the present disclosure, according to mechanical characteristics of the train and input and output data of the actual operation, a multi-particle model containing multiple coordinates is transformed into a unit-displacement model containing only one reference particle displacement by using a geometric relationship between adjacent cars, and based on the principle of action force and reaction force, a coupler force between cars is no longer explicitly included in the model, thereby establishing a multi-particle unit-displacement model of the heavy-haul train. Based on the multi-particle unit-displacement model, an active disturbance rejection control method is proposed. A tracking differentiator generates a transient process and a derivative of an input target signal, and an extended state observer estimates each state variable of a speed feedback value, to generate estimates of a speed, a speed derivative, and a total disturbance. Then, a nonlinear-combination controller designs a control law for error values between outputs of the tracking differentiator and the extended state observer based on a robust adaptive method, and compensates for the total disturbance according to each state variable of the estimated speed value and a real-time action amount of the total disturbance, so as to obtain an actual control amount acting on the heavy-haul train. Under the control of the active disturbance rejection controller, the train estimates and compensates for the total disturbance, and continuously reduces the error between the actual speed and the target speed, thereby improving the anti-interference capacity of the train and the accuracy of target speed tracking.

To make the objectives, features, and advantages of the present disclosure more obvious and comprehensive, the following further describes the present disclosure in detail with reference to the accompanying drawing and specific implementations.

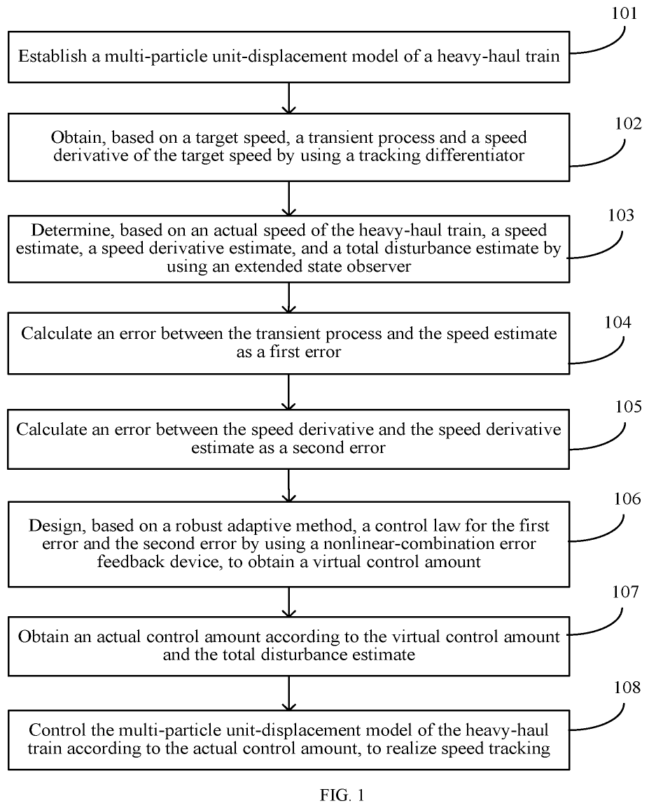

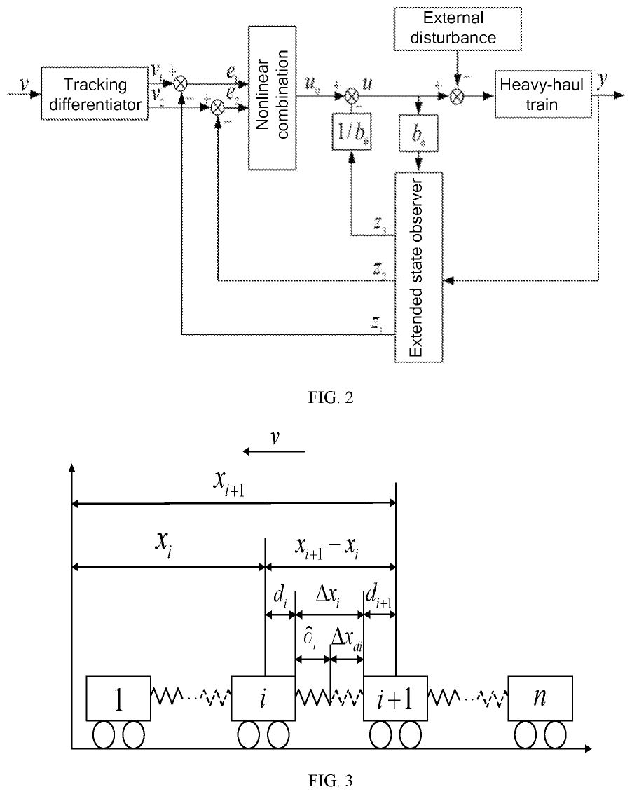

As shown in FIG. 1 and FIG. 2, a speed tracking control method for a heavy-haul train includes the following steps:

Step 101: establishing a multi-particle unit-displacement model of the heavy-haul train.

First, a multi-particle model of the heavy-haul train is established. Then, the first car is selected as a reference particle, and a unit-displacement model that only contains the displacement of the first car is obtained by using a geometric relationship between the remaining cars and the first car. Next, n equations of the unit-displacement model of the train are summed. Based on the principle of action force and reaction force, coupler forces between cars after summation cancel each other out, and the multi-particle unit-displacement model of the heavy-haul train is obtained.

Step 102: obtaining, based on a target speed, a transient process and a speed derivative of the target speed by using a tracking differentiator.

Step 103: determining, based on an actual speed of the heavy-haul train, a speed estimate, a speed derivative estimate, and a total disturbance estimate by using an extended state observer.

Step 104: calculating an error between the transient process and the speed estimate as a first error.

Step 105: calculating an error between the speed derivative and the speed derivative estimate as a second error.

Step 106: designing, based on a robust adaptive method, a control law for the first error and the second error by using a nonlinear-combination error feedback device, to obtain a virtual control amount.

Step 107: obtaining an actual control amount according to the virtual control amount and the total disturbance estimate.

Step 108: controlling the multi-particle unit-displacement model of the heavy-haul train according to the actual control amount, to realize speed tracking.

The modeling and control design in this method are described in detail below:

1. Establishment of the multi-particle unit-displacement model of the heavy-haul train: Each car of the heavy-haul train is regarded as one particle, and the entire train is regarded as a chain of particles. Then, a longitudinal dynamics equation of motion of the train is as follows:

$$\{ \begin{matrix}{m}_{1} {\ddot{x}}_{1} = {U}_{1} - {F}_{C 1} - {F}_{W 1} \\ {m}_{2} {\ddot{x}}_{2} = {U}_{2} + {F}_{C 1} - {F}_{C 2} - {F}_{W 2} \\ … \\ {m}_{i} {\ddot{x}}_{i} = {U}_{i} + {F}_{C i - 1} - {F}_{C i} - {F}_{W i} \\ … \\ {m}_{n} {\ddot{x}}_{n} = {U}_{n} + {F}_{C n - 1} - {F}_{C n} - {F}_{W n}\end{matrix} \qquad ( 1 )$$

where mᵢ represents the mass of the i-th car of the train; xᵢ represents a longitudinal displacement of the i-th car of the train; \dot{x}ᵢ and \ddot{x}₁ represent a speed and an acceleration of the i-th car respectively; U_{L} represents a traction/braking force of the train; F_{Ci-1} and F_{Ci} represent a front coupler force and a rear coupler force of the i-th car respectively; F_{Wi} represents a basic resistance of the i-th car.

Establishment of the unit-displacement model of the train: The multi-displacement model is transformed into a unit-displacement model containing only one reference particle. As shown in FIG. 3, which is a diagram of simplified car connection of the heavy-haul train, the first car is selected as a reference particle, where xᵢ represents a distance from the center of the i-th car to the reference particle, Δxᵢ=∂ᵢ+Δx_{di} represents a length of a connecting part between the i-th car and the (i+1)-th car, ∂ᵢ is an original length of the corresponding connecting part before any elastic deformation, and Δx_{di} represents an elastic deformation amount of the i-th elastic connecting body when being stretched or compressed. The following relational expression may be obtained through analysis:

Δx_{di}=xᵢ₊₁−xᵢ−dᵢ₊₁−dᵢ−∂ᵢ (2)

where dᵢ₊₁, dᵢ, and ∂ₜ are constants, and thus the following equation can be obtained:

Δ\dot{x}_{di}=\dot{x}ᵢ₊₁−\dot{x}ᵢ (3)

According to the variable relationship between formulas (2) and (3), xᵢ may be expressed as follows by using xᵢ and Δ\dot{x}_{di}:

\dot{x}ᵢ=\dot{x}₁+Σⱼ₌₁ⁱ⁻¹Δ\dot{x}_{dj}(i=2,3, . . . ,n) (4)
\ddot{x}₁ is expressed as follows by using \ddot{x}₁ and Δx_{di}:

\ddot{x}ᵢ=\ddot{x}₁+Σⱼ₌₁ⁱ⁻¹Δ\ddot{x}_{dj}(i=2,3, . . . ,n) (5)

By substituting equation (5) into multiple coordinates in the multi-particle longitudinal dynamics equation (1) of the train, the equation (1) can be transformed into a form containing only one coordinate:

$$\{ \begin{matrix}{m}_{1} {\ddot{x}}_{1} = {U}_{1} - {F}_{C 1} - {F}_{W 1} \\ {m}_{2} {\ddot{x}}_{1} = {U}_{2} + {F}_{C 1} - {F}_{C 2} - {F}_{W 2} - {m}_{2} {\sum }_{j = 1}^{1} {\ddot{Δ x}}_{dj} \\ … \\ {m}_{1} {\ddot{x}}_{1} = {U}_{i} + {F}_{C i - 1} - {F}_{C i} - {F}_{W i} - {m}_{i} {\sum }_{j = 1}^{i - 1} {\ddot{Δ x}}_{dj} \\ … \\ {m}_{n} {\ddot{x}}_{1} = {U}_{n} + {F}_{C n - 1} - {F}_{C n} - {F}_{W n} - {m}_{n} {\sum }_{j = 1}^{n - 1} {\ddot{Δ x}}_{a j}\end{matrix} \qquad ( 6 )$$

Equation (6) shows mutual influence between adjacent cars, and also reflects mutual influence between other cars and a reference car. This model can clearly describe dynamic behaviors of the train during the whole operation of the train. However, it is difficult to simulate and measure the coupler force F_{Ci}(⋅) in the equation, which is adverse to the design of the controller. Therefore, based on the law of “action force and reaction force”, the equation (6) is transformed again, and the n equations are summed, so that the coupler forces between cars cancel each other out, to obtain the following equation:

$$\begin{matrix} M {\ddot{x}}_{1} = U - {F}_{W} - {F}_{L} & ( 7 ) \\ where , & \\ M = {\sum }_{i = 1}^{n} {m}_{i} \\ U = {\sum }_{i = 1 \\ 8}^{n} {U}_{i} = {U}_{1} & \\ and & \\ {R}_{W} + {F}_{L} = {A}_{0} + {A}_{1} {\dot{x}}_{1} + {A}_{2} {\dot{x}}_{1}^{2} & ( 8 ) \\ where , & \\ {A}_{0} = {\sum }_{i = 1}^{n} {a}_{1} ( i ) {\sum }_{j = 1}^{i - 1} Δ {\dot{x}}_{dj} + {\sum }_{i = 1}^{n} {a}_{1} ( i ) {( {\sum }_{j = 1}^{i - 1} Δ {\dot{x}}_{dj} )}^{2} + {\sum }_{i = 1}^{n - 1} Δ {\ddot{x}}_{di} {\sum }_{j = i + 1}^{n} {m}_{j} + {\sum }_{i = 1}^{N} {a}_{0} ( i ) \\ {A}_{1} = 2 {\sum }_{i = 1}^{n} {a}_{2} ( i ) {\sum }_{j = 1}^{i - 1} Δ {\dot{x}}_{dj} + {\sum }_{i = 1}^{n} {a}_{1} ( i ) \\ {A}_{2} = {\sum }_{i = 1}^{n} {a}_{2} ( i ) & \end{matrix}$$

The coupler forces between cars cancel each other out, leaving only the mutual influence F_{L} between other cars and the reference car. Therefore, during design of the control strategy of heavy-haul train, it is no longer necessary to discuss the design of coupler force modeling.

In summary, if the displacement of the reference car of the heavy-haul train is defined as xₐ, then \dot{x}ₐ=vₐ, where vₐ and \dot{v}ₐ are a speed and an acceleration of the reference car respectively; the multi-particle unit-displacement model of the heavy-haul train may be obtained:

M\dot{v}ₐ=U−F_{W}−F_{L} (9)

Meanwhile, a second-order model of the heavy-haul train is as follows:

$$\{ \begin{matrix}{\dot{x}}_{a} = {v}_{a} \\ {\dot{v}}_{a} = f ( {x}_{a} , {v}_{a} , w , t ) + {b}_{0} u \\ y = {v}_{a}\end{matrix} \qquad ( 10 )$$

In equation (10), u is a control amount, y is a system output of the heavy-haul train, and ƒ(xₐ, vₐ, w, t) is an uncertainty function including unmodeled dynamics of the train and unknown external disturbances.

2. Design of the robust-adaptive active disturbance rejection controller: The control technology consists of three main components: a tracking differentiator, an extended state observer, and a nonlinear state error feedback control law based on the extended state observer. Based on the nonlinear feedback law u₀ of the active disturbance rejection controller, robust-adaptive nonlinear combination is performed by using the transient process and the derivative of the speed signal that are generated by the differential tracker and errors between the state variable estimates of the speed feedback value that are generated by the extended state observer. Nonlinear control with “small error and large gain, or large error and small gain” can be implemented by selecting suitable controller parameters. Moreover, the total disturbance of the train system is compensated for by the extended state observer, to obtain the control amount u acting on the train, thereby completing high-precision speed tracking during high-speed train operation.

Design of the tracking differentiator: v is the input target speed. To ensure the high-precision tracking control of the system, it is necessary to obtain a high-quality tracking target input. Therefore, the tracking differentiator provides a transient process v₁ for the input target speed and obtains a differential signal v₂ of the target speed, so that the input target speed of the system increases smoothly from zero, to avoid chattering and effectively resist the impact of random noise. In addition, the transient process v₁ of the input target speed will be used as a target speed actually tracked by the train. The tracking differentiator is designed as follows:

$$\{ \begin{matrix}{v}_{1} ( k + 1 ) = {v}_{1} ( k ) + h {v}_{2} ( k ) \\ {v}_{2} ( k + 1 ) = {v}_{2} ( k ) + {h}^{*} fhan\end{matrix} \qquad ( 11 )$$

In the equation, ƒhan is a time-optimal synthesis function, which is used to enable the control system to track the input signal in a fastest way, and may be specifically expressed as follows:

$$\begin{matrix}f h a n ( {x}_{a} , {v}_{a} , δ , h ) = \{ \begin{matrix}- δ sgn ( α ) \vert α \vert > d \\ - δ \frac{α}{d} \vert α \vert \leq d \end{matrix} & ( 12 ) \\ α = \{ \begin{matrix}{v}_{a} + \frac{{α}_{0} - d}{2} sgn ( {v}_{a} ) & \vert y \vert > {d}_{0} \\ {v}_{a} + y / h & \vert y \vert \leq {d}_{0}\end{matrix} & ( 13 )\end{matrix}$$

In the equation d=δh; d₀=hd; y=xₐ+hvₐ; and α₀\sqrt{d₂+8δ|y|}.

In the equation above, h is an integration step, and δ is a speed tracking factor. Parameters that need to be adjusted are the filter factor h and the speed factor δ. The principle of adjusting the integral step is to maximize the integration step while ensuring that the signal is not distorted, without causing the loss of the system signal phase; the speed factor affects the tracking speed of the signal, and also needs to be maximized, without causing a high overshoot of the output signal to affect the tracking performance of the system. The filter factor is set as follows: h=0.01, and the speed factor is set as follows: δ=10.

Design of the extended state observer: First, the total disturbance ƒ(xₐ, vₐ, w, t) of the train system is regarded as an extended state ƒ=g, and then g=ƒ(xₐ, vₐ, w, t), which is the unknown part of the train. It can be obtained from equation (10) that:

\dot{v}ₐ=g+bu (14)

Equation (10) is extended to be a new system, where a state equation thereof is as follows:

$$\{ \begin{matrix}{\dot{x}}_{a} = {v}_{a} \\ {\dot{v}}_{a} = f + {b}_{0} u \\ \dot{f} = \dot{g} \\ y = {v}_{a}\end{matrix} \qquad ( 15 )$$

vₐ, \dot{v}ₐ, and ƒ are observed by using the extended state observer, to obtain observation results z₁, z₂, z₃, where the estimates are expressed as follows:

$$\{ \begin{matrix}e = {z}_{1} - y \\ {\dot{z}}_{1} = {z}_{2} - {β}_{1} e \\ {\dot{z}}_{2} = {z}_{3} - {β}_{2} fa l ( e , 0.5 , τ ) + {b}_{0} u \\ {\dot{z}}_{3} = - {β}_{3} fa l ( e , 0.25 , τ )\end{matrix} \qquad ( 16 )$$

In the equation, β₁, β₂, β₃ are gain parameters of the system controller, and with a proper gain configuration, the observer can better estimate actual values of system state variables; b₀ is a compensation factor, which determines the magnitude of compensation for the unknown part; ƒal(e, a, τ) is a nonlinear saturation function, which is mainly used to suppress the chattering intensity of the signal, where r determines a width of a nonlinear interval in the function, and the function ƒal (e, a, τ) is defined as follows:

$$fa l ( e , a , τ ) = \{ \begin{matrix}\frac{e}{{τ}^{1 - α}} & \vert e \vert \leq τ \\ {\vert e \vert}^{α} sign ( e ) & \vert e \vert > τ\end{matrix} \qquad ( 17 )$$

In the actual control system, there is no need to know whether the function ƒ(xₐ, Vₐ, w, t) is continuous or known. As long as the function is a bounded and the control amount gain b₀ is known, suitable parameter values of z₁, z₂, z₃ can be obtained through adjustment, to finally obtain observed values of vₐ, \dot{v}ₐ, and ƒ.

Design of the robust-adaptive active disturbance rejection controller: Xᵣ is introduced as an expected displacement of the train; xₐ is an actual displacement; vₐ and \dot{v}ₐ are a speed and an acceleration of the train respectively. In this case, xₐ−Xᵣ, vₐ−v₁, and \dot{v}ₐ−c₂ are a displacement tracking error, a speed tracking error, and an acceleration tracking error of the train respectively. It is assumed that Xᵣ is known to be smooth and bounded, and v₁, v₂ are present and bounded.

To facilitate the design of the controller, a filter variable is first defined as follows:

s=(vₐ−v₁)+β(xₐ−Xᵣ) (18)

In equation (18), β is an adjustable positive real number. Based on the multi-particle unit-displacement model of the train in equation (7), the derivative of equation (18) is obtained as follows:

$$\dot{s} = \frac{1}{M} U - \frac{{F}_{W} + {F}_{L}}{M} - {v}_{2} + β ( {v}_{a} - {v}_{1} ) \qquad ( 19 )$$

Based on the definition of the filter variable, equation (7) may be re-described as follows:

M\dot{s}=U+L_{d} (20)

In equation (20), L_{d} is the total uncertainty of the system, consisting of the unmodeled dynamics and unknown external interference.

L_{d}=M(v₂−βė)−(A₀+A₁vₐ+A₂Vₐ²) (21)

The control objective of the controller is to design a suitable control input for the train system under the uncertainty of L_{d}, to ensure that the actual speed of the train can accurately track the target speed, while the closed-loop system is stable and all signals are bounded.

Analysis and design are carried out based on the model formula (7) Since it is difficult to obtain A₀, A₁, A₂ in practice, it is difficult to calculate the value of L_{d}. Therefore, a control method that does not rely on L_{d} needs to be established in the control scheme. In this study, only two sensors at most are used to measure the displacement x₁ and the speed vₐ of the reference car, without considering the measurement of xᵢ and vₐᵢ of any other car. It is only necessary to assume there are unknown constants C₁ᵢ and C₂ᵢ such that |Δ\dot{x}_{di}|≤C₁ᵢ<∞ and |Δ\ddot{x}_{di}|≤C₂ᵢ<∞. Such an assumption is reasonable throughout the regular operation of the train.

Based on the above assumption and definition, combined with the bounded parameters of the basic resistance, and the bounded target displacement and speed, the following inequality can be established, that is, there are unknown constants b₁, b₂, b₃ such that L_{d} in the formula satisfies the following relationship:

|L_{d}|≤q₁+q₂|vₐ|+q₃|vₐ|²≤qΦ (22)

Herein, q=max{q₁,q₂,q₃} and Φ>=|ₐ|+|vₐ|². In formula (22), it is difficult to obtain accurate information of q, but it is easy to calculate the variable Φ that carries core information of the unknown term L_{d}.

To achieve the control objective, the control law of the system is designed as follows:

$$\begin{matrix}{u}_{0} = - [ {k}_{0} + \frac{\hat{b} {Φ}^{2}}{Φ \vert s \vert + λ ( t )} ] s & ( 23 ) \\ and & \\ \dot{\hat{b}} = - {σ}_{0} \hat{b} + {σ}_{1} \frac{{Φ}^{2} {\vert s \vert}^{2}}{Φ \vert s \vert + λ ( t )} & ( 24 )\end{matrix}$$

where k₀>0, σ₀>0, σ₁>0, Φ=1+|vₐ|+|vₐ|², and 0<λ(t)≤λ₀<∞; λ₀ is a constant; \hat{b} is an adaptive parameter reflecting an estimation error boundary of the extended state observer; \hat{\dot{b}} is an adaptive law, where the function term −σ₀b in equation (24) may be used to verify and adjust the rate of change of \hat{b} to avoid a parameter drift. Finally, bounded speed tracking of the train can be realized. Finally, by combining the extended state controller and the non-linear combination component, the control amount u formed by disturbance compensation, where u directly acts on the controlled train, which is expressed as follows:

$$u = \frac{{u}_{0} - {z}_{3}}{{b}_{0}} \qquad ( 25 )$$

### Specific Embodiment

The implementation of the present disclosure is based on a train characteristic curve, and 3380 sets of real input and output data about the operation of the heavy-haul train are obtained. The specific implementation includes comparing, in the presence of interference, the tracking effect of the robust-adaptive active disturbance rejection controller with the tracking effect of the conventional PID controller.

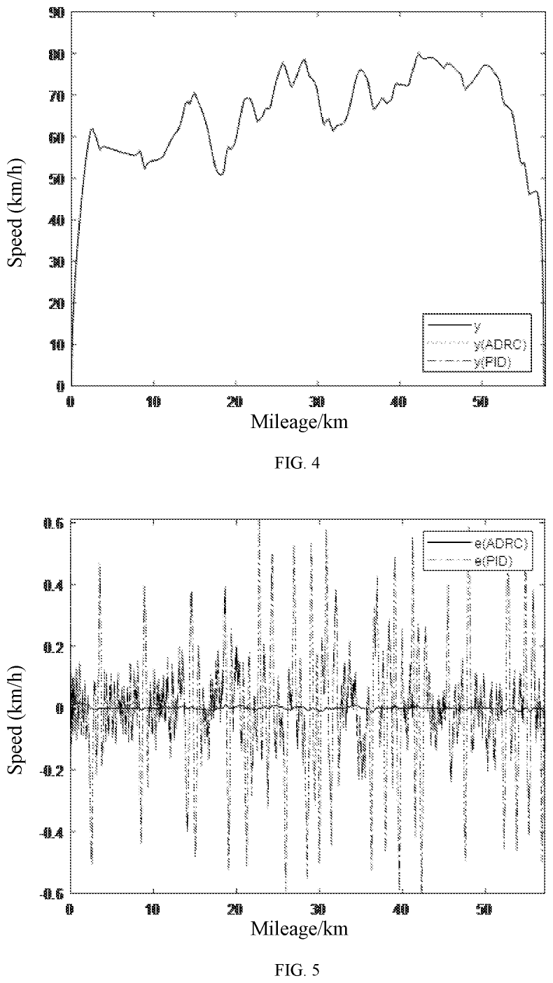

FIG. 4 is a diagram of comparison between speed tracking of the active disturbance rejection controller and speed tracking of the PID controller. It can be seen from the figure that both controllers can achieve stable tracking without overshoot.

FIG. 5 shows the tracking errors of the two controllers. It is obvious that the speed error under the PID controller constantly fluctuates in a range of [−0.6, 0.6], while the error under the active disturbance rejection controller changes within a range of [−0.02, 0.02], indicating that the tracking effect of the active disturbance rejection controller is obviously better than that of the PID controller, and the active disturbance rejection controller has better anti-interference capacity than the PID controller, thus achieving a more stable tracking effect and higher tracking accuracy.

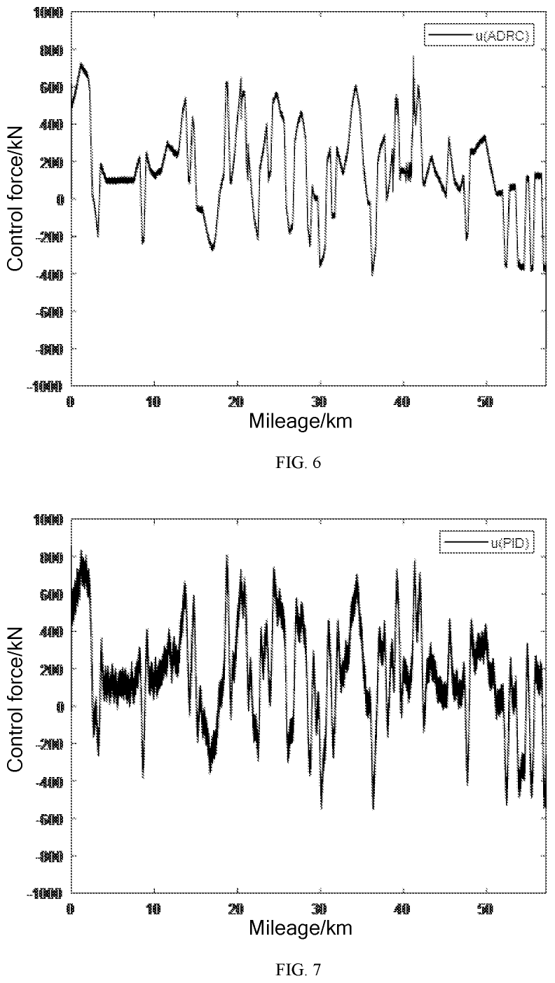

FIG. 6 and FIG. 7 show control forces of the two controllers. In the presence of interference, the control force of the active disturbance rejection controller is obviously smoother than that of the PID controller, and has smaller jitter, which is more in line with the characteristics of the locomotive and meets the traction/braking power output conditions of the locomotive. Various simulation results show that during control of the train operation, the robust-adaptive active disturbance rejection controller is more advantageous than the PID control in terms of tracking accuracy and control force requirements.

The present disclosure further provides a speed tracking control system for a heavy-haul train, including: a model establishment module, a first parameter determining module, a second parameter determining module, a first error calculation module, a second error calculation module, a virtual control amount determining module, an actual control amount determining module, and a control module.

The model establishment module is configured to establish a multi-particle unit-displacement model of the heavy-haul train. The model establishment module specifically includes: a unit for establishing multi-particle model of heavy-haul train, configured to establish a multi-particle model of the heavy-haul train according to a dynamics equation of the heavy-haul train; a transformation unit, configured to transform the multi-particle model of the heavy-haul train into a unit-displacement model containing only one reference particle displacement by using a geometric relationship between adjacent cars; and a unit for establishing multi-particle unit-displacement model of heavy-haul train, configured to transform the unit-displacement model containing only one reference particle displacement into the multi-particle unit-displacement model of the heavy-haul train by using a principle of “action force and reaction force”. The first parameter determining module is configured to obtain, based on a target speed, a transient process and a speed derivative of the target speed by using a tracking differentiator. The second parameter determining module is configured to determine, based on an actual speed of the heavy-haul train, a speed estimate, a speed derivative estimate, and a total disturbance estimate by using an extended state observer. The first error calculation module is configured to calculate an error between the transient process and the speed estimate as a first error. The second error calculation module is configured to calculate an error between the speed derivative and the speed derivative estimate as a second error. The virtual control amount determining module is configured to design, based on a robust adaptive method, a control law for the first error and the second error by using a nonlinear-combination error feedback device, to obtain a virtual control amount. The actual control amount determining module is configured to obtain an actual control amount according to the virtual control amount and the total disturbance estimate. The control module is configured to control the multi-particle unit-displacement model of the heavy-haul train according to the actual control amount, to realize speed tracking.

Each embodiment of the present specification is described in a progressive manner, each embodiment focuses on the difference from other embodiments, and for the same and similar parts between the embodiments, reference may be made to each other. For the system disclosed in the embodiments, since the system corresponds to the method disclosed in the embodiments, the description is relatively simple, and reference can be made to the description of the method.

In this specification, several specific embodiments are used for illustration of the principles and implementations of the present disclosure. The description of the foregoing embodiments is used to help illustrate the method of the present disclosure and the core ideas thereof. In addition, those of ordinary skill in the art can make various modifications in terms of specific implementations and scope of application in accordance with the ideas of the present disclosure. In conclusion, the content of the present specification shall not be construed as a limitation to the present disclosure.

What is claimed is:

1. A speed tracking control method for a heavy-haul train, comprising:
establishing a multi-particle unit-displacement model of the heavy-haul train;
obtaining, based on a target speed, a transient process and a speed derivative of the target speed by using a tracking differentiator;
determining, based on an actual speed of the heavy-haul train, a speed estimate, a speed derivative estimate, and a total disturbance estimate by using an extended state observer;
calculating an error between the transient process and the speed estimate as a first error;
calculating an error between the speed derivative and the speed derivative estimate as a second error;
designing, based on a robust adaptive method, a control law for the first error and the second error by using a nonlinear-combination error feedback device, to obtain a virtual control amount;
obtaining an actual control amount according to the virtual control amount and the total disturbance estimate; and
controlling the multi-particle unit-displacement model of the heavy-haul train according to the actual control amount, to realize speed tracking.

2. The speed tracking control method for a heavy-haul train according to claim 1, wherein the establishing a multi-particle unit-displacement model of the heavy-haul train specifically comprises:
establishing a multi-particle model of the heavy-haul train according to a dynamics equation of the heavy-haul train;
transforming the multi-particle model of the heavy-haul train into a unit-displacement model containing only one reference particle displacement by using a geometric relationship between adjacent cars; and
transforming the unit-displacement model containing only one reference particle displacement into the multi-particle unit-displacement model of the heavy-haul train by using a principle of “action force and reaction force”.

3. The speed tracking control method for a heavy-haul train according to claim 2, wherein the multi-particle model of the heavy-haul train is as follows:
$$\{ \begin{matrix}{m}_{1} {\ddot{x}}_{1} = {U}_{1} - {F}_{C 1} - {F}_{W 1} \\ {m}_{2} {\ddot{x}}_{2} = {U}_{2} + {F}_{C 1} - {F}_{C 2} - {F}_{W 2} \\ … \\ {m}_{i} {\ddot{x}}_{i} = {U}_{i} + {F}_{C i - 1} - {F}_{C i} - {F}_{W i} \\ … \\ {m}_{n} {\ddot{x}}_{n} = {U}_{n} + {F}_{C n - 1} - {F}_{C n} - {F}_{W n}\end{matrix}$$
wherein mᵢ represents the mass of the i-th car of the train; \ddot{x}₁ represent an acceleration of the i-th car; Uᵢ represents a traction/braking force of the i-th car of the train; F_{Ci-1} and F_{Ci} represent a front coupler force and a rear coupler force of the i-th car respectively; and F_{Wi} represents a basic resistance of the i-th car.

4. The speed tracking control method for a heavy-haul train according to claim 2, wherein the multi-particle unit-displacement model of the heavy-haul train is as follows:
M\dot{v}ₐ=U−F_{W}−F_{L}
wherein M is the total mass of the train; U is a control amount applied to the train; F_{L} is mutual influence of other cars on a reference car; F_{W} is a total resistance of the train; if a displacement of the reference car of the heavy-haul train is defined as xₐ, then \dot{x}ₐ=vₐ; vₐ and \dot{v}ₐ, are a speed and an acceleration of the reference car respectively.

5. The speed tracking control method for a heavy-haul train according to claim 1, wherein a formula for calculating the actual control amount is as follows:
$$u = \frac{{u}_{0} - {z}_{3}}{{b}_{0}}$$
wherein u represents the actual control amount, u₀ represents the virtual control amount, b₀ represents a compensation factor, and z₃ represents the total disturbance estimate.

6. A speed tracking control system for a heavy-haul train, comprising:
a model establishment module, configured to establish a multi-particle unit-displacement model of the heavy-haul train;
a first parameter determining module, configured to obtain, based on a target speed, a transient process and a speed derivative of the target speed by using a tracking differentiator;
a second parameter determining module, configured to determine, based on an actual speed of the heavy-haul train, a speed estimate, a speed derivative estimate, and a total disturbance estimate by using an extended state observer;
a first error calculation module, configured to calculate an error between the transient process and the speed estimate as a first error;
a second error calculation module, configured to calculate an error between the speed derivative and the speed derivative estimate as a second error;
a virtual control amount determining module, configured to design, based on a robust adaptive method, a control law for the first error and the second error by using a nonlinear-combination error feedback device, to obtain a virtual control amount;
an actual control amount determining module, configured to obtain an actual control amount according to the virtual control amount and the total disturbance estimate; and
a control module, configured to control the multi-particle unit-displacement model of the heavy-haul train according to the actual control amount, to realize speed tracking.

7. The speed tracking control system for a heavy-haul train according to claim 6, wherein the model establishment module specifically comprises:
a unit for establishing multi-particle model of heavy-haul train, configured to establish a multi-particle model of the heavy-haul train according to a dynamics equation of the heavy-haul train;
a transformation unit, configured to transform the multi-particle model of the heavy-haul train into a unit-displacement model containing only one reference particle displacement by using a geometric relationship between adjacent cars; and
a unit for establishing multi-particle unit-displacement model of heavy-haul train, configured to transform the unit-displacement model containing only one reference particle displacement into the multi-particle unit-displacement model of the heavy-haul train by using a principle of “action force and reaction force”.

8. The speed tracking control system for a heavy-haul train according to claim 7, wherein the multi-particle model of the heavy-haul train is as follows:
$$\{ \begin{matrix}{m}_{1} {\ddot{x}}_{1} = {U}_{1} - {F}_{C 1} - {F}_{W 1} \\ {m}_{2} {\ddot{x}}_{2} = {U}_{2} + {F}_{C 1} - {F}_{C 2} - {F}_{W 2} \\ … \\ {m}_{i} {\ddot{x}}_{i} = {U}_{i} + {F}_{C i - 1} - {F}_{C i} - {F}_{W i} \\ … \\ {m}_{n} {\ddot{x}}_{n} = {U}_{n} + {F}_{C n - 1} - {F}_{C n} - {F}_{W n}\end{matrix}$$
wherein mᵢ represents the mass of the i-th car of the train; \ddot{x}₁ represent an acceleration of the i-th car; Uᵢ represents a traction/braking force of the i-th car of the train; F_{Ci-1} and F_{Ci} represent a front coupler force and a rear coupler force of the i-th car respectively; and F_{Wi} represents a basic resistance of the i-th car.

9. The speed tracking control system for a heavy-haul train according to claim 7, wherein the multi-particle unit-displacement model of the heavy-haul train is as follows:
M\dot{v}ₐ=U−F_{W}−F_{L}
wherein M is the total mass of the train; U is a control amount applied to the train; F_{L} is mutual influence of other cars on a reference car; F_{W} is a total resistance of the train; if a displacement of the reference car of the heavy-haul train is defined as xₐ, then \dot{x}ₐ=vₐ; vₐ and \dot{v}ₐ are a speed and an acceleration of the reference car respectively.

10. The speed tracking control system for a heavy-haul train according to claim 6, wherein a formula for calculating the actual control amount is as follows:
$$u = \frac{{u}_{0} - {z}_{3}}{{b}_{0}}$$
wherein u represents the actual control amount, u₀ represents the virtual control amount, b₀ represents a compensation factor, and z₃ represents the total disturbance estimate.
